(19) United States
(12) Patent Application Publication
(10) Pub. No.: US 2013/0087609 A1
(43) Pub. Date: Apr. 11, 2013

(54) Medical Device Tracking System and Method

(71) Applicants: Graham NICHOL, Mercer Island, WA (US); Adrian Todd EMERSON, Lake Forest Park, WA (US)

(72) Inventors: Graham NICHOL, Mercer Island, WA (US); Adrian Todd EMERSON, Lake Forest Park, WA (US)

(73) Assignee: The University of Washington through its Center for Commercialization, a public Institution of Hig, Seattle, WA (US)

(21) Appl. No.: 13/526,306

(22) Filed: Jun. 18, 2012

Related U.S. Application Data
(60) Provisional application No. 61/498,424, filed on Jun. 17, 2011.

(51) Int. Cl. G06F 17/30

(52) U.S. Cl. CPC G06F 17/30002
USPC 235/375

(57) ABSTRACT

Methods and systems for accurately tracking medical devices using a two-dimensional (2D) matrix code are disclosed. Scan data, location data, and status data may be received by a processor. The scan data may comprise identification information corresponding to a medical device; the location data may comprise location information corresponding to the medical device; and the status data may comprise status information corresponding to the medical device. Once the scan data, location data, and status data has been received, the scan data, the location data and the status data may be stored. Next, at least one medical-device characteristic may be determined, based on at least the scan data and the status data, and once the medical-device characteristic is determined, the medical-device characteristic may be displayed on a graphical display.

### RELATED APPLICATIONS

The present non-provisional utility application claims priority to U.S. Provisional Patent Application Ser. No. 61/498,424 filed on Jun. 17, 2011, which is hereby incorporated by reference in its entirety herein.

### FIELD OF THE INVENTION

The present disclosure relates to product tracking in time and space. In particular, this disclosure relates to a two-dimensional (2D) matrix code associated with a product or medical device, where the 2D matrix code is used to track location, viability, and/or authenticity of the product or device. One particular embodiment includes tracking a defibrillator device via periodic scanning of a 2D matrix barcode that is affixed to the defibrillator.

### BACKGROUND

Tracking physical products is important in a variety of industries. For example, in distribution and logistics it may be important to determine both the current location and past locations of a unique item or product. The identification of a product may be accomplished in a variety of ways, including using an identification label, such as a barcode or RFID tag. Typically, the identification label is affixed directly to the product. Unfortunately, an identification label that is affixed to the product is static, and may not itself indicate the current location or current status of the product. Consequently, a static identification label may not provide current location and status information after the label is affixed.

The medical industry is especially concerned with tracking existing products. In particular, the defibrillator industry has a great need for tracking deployed defibrillators. With over 1.2 million automated external defibrillators (AEDs) deployed in the United States, there is concern about manufacturers' ability to efficiently and accurately track these devices. The 2D-matrix code medical device tracking technology could be used to track medical devices as inventory before clinical use (e.g. disposable medical devices such as bandages) or after installation of the device in a community or hospital setting (e.g. durable medical equipment such as an AED) or before or after implantation of the device in a patient (e.g. pacemaker).

### SUMMARY

This disclosure describes, inter alia, methods and systems for accurately tracking physical products, such as medical devices, in time and space.

In one embodiment, a computer-implemented method is provided that includes receiving scan data comprising identification information corresponding to a medical device. The method includes receiving location data comprising location information corresponding to the medical device. The method also includes receiving status data comprising status information corresponding to the medical device. The method additionally includes causing the scan data, the location data, and the status data to be stored. The method further includes determining, based on at least the scan data and the status data, at least one medical-device characteristic. The method yet further includes causing a visual indication of the at least one medical-device characteristic to be displayed on a graphical display.

In another embodiment, a system is provided. The system includes a processor, a physical computer readable medium, and program instructions stored on the physical computer readable medium. The program instructions are executable by the processor to receive scan data comprising identification information corresponding to a medical device. The program instructions are executable to receive location data comprising location information corresponding to the medical device. The program instructions are also executable to receive status data comprising status information corresponding to the medical device. The program instructions are additionally executable to cause the scan data, the location data, and the status data to be stored. The program instructions are further executable to determine, based on at least the scan data and the status data, at least one medical-device characteristic. The program instructions are yet further executable to cause a visual indication of the at least one medical-device characteristic to be displayed on a graphical display.

In another embodiment a physical computer readable medium having instructions store thereon is provided. The instructions include instructions for receiving scan data comprising identification information corresponding to a medical device. The instructions include instructions for receiving location data comprising location information corresponding to the medical device. The instructions also include instructions for receiving status data comprising status information corresponding to the medical device. The instructions additionally include instructions for causing the scan data, the location data, and the status data to be stored. The instructions further include instructions for determining, based on at least the scan data and the status data, at least one medical-device characteristic. The instructions further include instructions for causing a visual indication of the at least one medical-device characteristic to be displayed on a graphical display.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE DRAWINGS

The following drawings in conjunction with the detailed description may be used to understand how the various embodiments of the present invention provide the stated and further advantages.

FIG. 1 illustrates a product identification system 100, in accordance with an example embodiment.

FIG. 2 illustrates a product identification and monitoring server, in accordance with an example embodiment.

FIG. 3 illustrates another product identification system, in accordance with an example embodiment.

FIG. 4 illustrates a Defibrillator/Monitor system interacting with the system of FIG. 3, in accordance with an example embodiment.

FIG. 5 illustrates a Defibrillator Device Database, in accordance with an example embodiment of the system shown in FIG. 4.

FIG. 6 illustrates graphical representations of various Quick Response (QR) code operational states for use on a Defibrillator/Monitor, in accordance with an example embodiment.

FIG. 7 illustrates graphical representations of various 2D matrix code operational states for use on a Defibrillator/Monitor, in accordance with an example embodiment.

FIG. 8 illustrates a flow diagram for a Product Discovery and Validation Process, in accordance with an example embodiment.

FIG. 9 illustrates a flow diagram for a Location Identification and Product Association Process, in accordance with an example embodiment.

FIG. 10 illustrates a flow diagram for a Product Monitoring and Maintenance Process, in accordance with an example embodiment.

FIG. 11 illustrates a flow diagram for a Product Usage, Data Collection and Restoration Process, in accordance with an example embodiment.

### DETAILED DESCRIPTION

The following detailed description includes references to the accompanying figures. In the figures, similar symbols typically identify similar components, unless context dictates otherwise. The example embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein and illustrated in the figures may be arranged, substituted, combined, separated, and designed in a wide variety of different configurations, all of which are contemplated herein.

The detailed description that follows is represented largely in terms of processes and symbolic representations of operations that may be executed by conventional computer components, including a processor, memory storage devices for the processor, connected display devices and input devices. Furthermore, these processes and operations may utilize conventional computer components in a heterogeneous distributed computing environment, including remote file servers, computer servers, and memory storage devices. Each of these conventional distributed computing components is accessible by the processor via a communication network. In a heterogeneous computing environment, clients, servers, and client/servers may be, for example, mainframes, minicomputers, workstations, or personal computers. Most services in a heterogeneous computing environment may be grouped into one of these major categories: distributed file system, distributed computing, and messaging. A distributed file system provides a client with transparent access to part of the mass storage of a remote server.

Unless explicitly specified, a system or a computer system, as used herein, implies a system with the capabilities of a machine based on the Von Neumann architecture. Within the context of the disclosure, a computer system may also be referred as a node. Further, the term device refers to a system that need not have this capability. A computer network, as used herein, refers to a group of computers and associated devices that are connected by communication.

Various aspects of the illustrative embodiments will be described using terms commonly employed by those skilled in the art to convey the substance of their work to others skilled in the art. However, the embodiments described herein may be practiced with only some of the described aspects. For purposes of explanation, specific numbers, materials, and configurations may be set forth to provide a thorough understanding of the illustrative embodiments. However, the embodiments described herein may be practiced without the specific details. In other instances, well-known features are omitted or simplified in order not to obscure the illustrative embodiments.

Further, various operations and/or communications may be described as multiple discrete operations and/or communications, in turn, in a manner that may be helpful in understanding the embodiments described herein; however, the order of description should not be construed as to imply that these operations and/or communications are necessarily order dependent. In particular, these operations and/or communications need not be performed in the order of presentation.

The phrases “in one embodiment,” “in an example embodiment,” and “an embodiment” are used repeatedly throughout this disclosure. The phrases generally do not refer to the same embodiment; however, they may. The terms “comprising,” “having,” and “including” are synonymous, unless the context dictates otherwise. The terms “2-D matrix code,” “2D matrix code,” and “matrix barcode” are synonymous and generally refer to a 2D matrix code that a scanner may read both horizontally and vertically, and some 2D matrix codes may contain information in an encrypted form. Many 2D matrix codes have been optimized for use with cell phones such that they may be read quickly and accurately with or without an auto-focus camera, for example. There are a variety of different 2D matrix codes including, but not limited to Quick Response (QR) codes, Data Matrix codes, Aztec codes, MaxiCode, Semacode tags, Cauzin Softstrip codes, EZcode, High Capacity Color Barcode (HCCB), CyberCode, Mobile Multi-Coloured Composite (MMCC), Dot codes, PDF417 symbols, ShotCode, SPARQCode, WaterCode, and Trusted Paper Key (TPK), for example.

### A. Overview

This disclosure describes, inter alia, methods and systems for accurately tracking products such as medical devices. Scan data, location data, and status data may be received by a processor. The scan data may comprise identification information corresponding to a medical device; the location data may comprise location information corresponding to the medical device; and the status data may comprise status information corresponding to the medical device. Once the scan data, location data, and status data have been received, the scan data, the location data, and the status data may be stored. Next, at least one medical-device-characteristic may be determined, based on at least the scan data and the status data, and once the medical-device-characteristic has been determined, the medical-device-characteristic may be displayed on a graphical display.

In some embodiments the foregoing method may be used to track medical devices, which may include any instruments or related articles which are intended for use in the diagnosis or treatment of disease. Such devices are applied externally or internally to patients to affect the structure or function of their body, and do not achieve their purpose through chemical action or metabolism. Example medical devices may include durable medical equipment (e.g. wheelchairs), externally-applied devices (e.g. automated external defibrillator), internally-applied devices (e.g. pacemaker) or disposable medical devices (e.g. bandages). Other medical devices may include a blood glucose monitor, a blood pressure monitor, a dialysis machine, an electrocardiography (ECG) machine, a wireless monitor, a laryngoscope, a bronchoscope, a pacemaker, or a stent, for example. The tracking of these medical devices may include tracking information including identification information, location information, and status information, which will be described in greater detail throughout this disclosure. In other embodiments, more or less information may be tracked.

In one example embodiment, a particular monitor or defibrillator, such as an automated external defibrillator (AED), may be tracked by periodically scanning a 2D matrix code label affixed to the monitor or defibrillator. The location, viability, and/or authenticity of the defibrillator may be tracked, for example. The 2D matrix code may also allow for real-time instructions to be provided while the monitor or defibrillator is being used.

### B. Example Systems

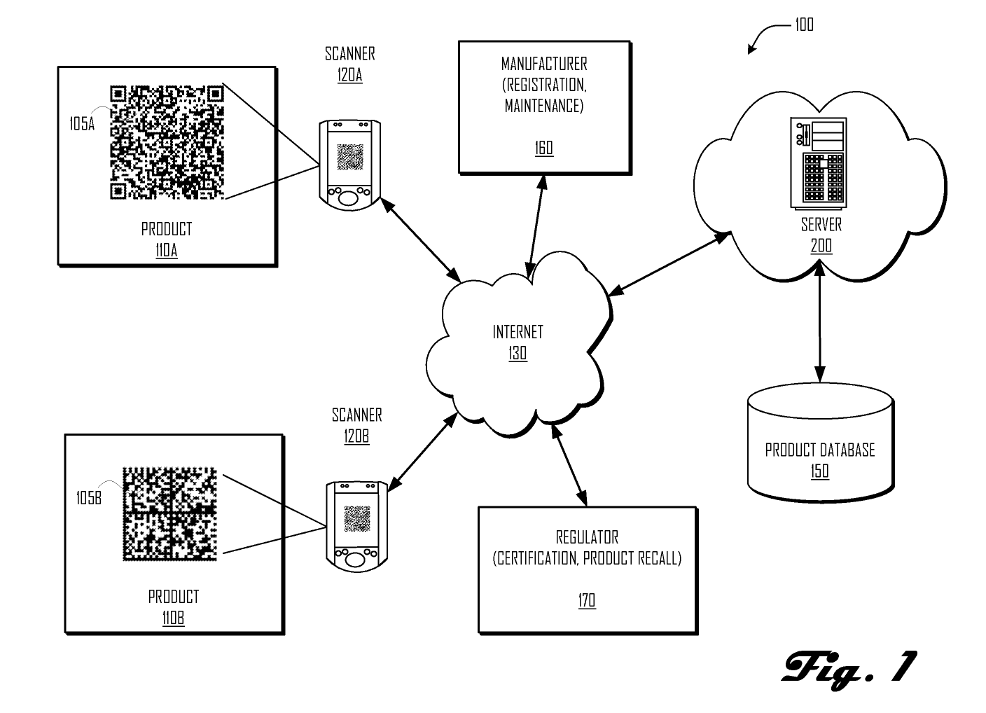

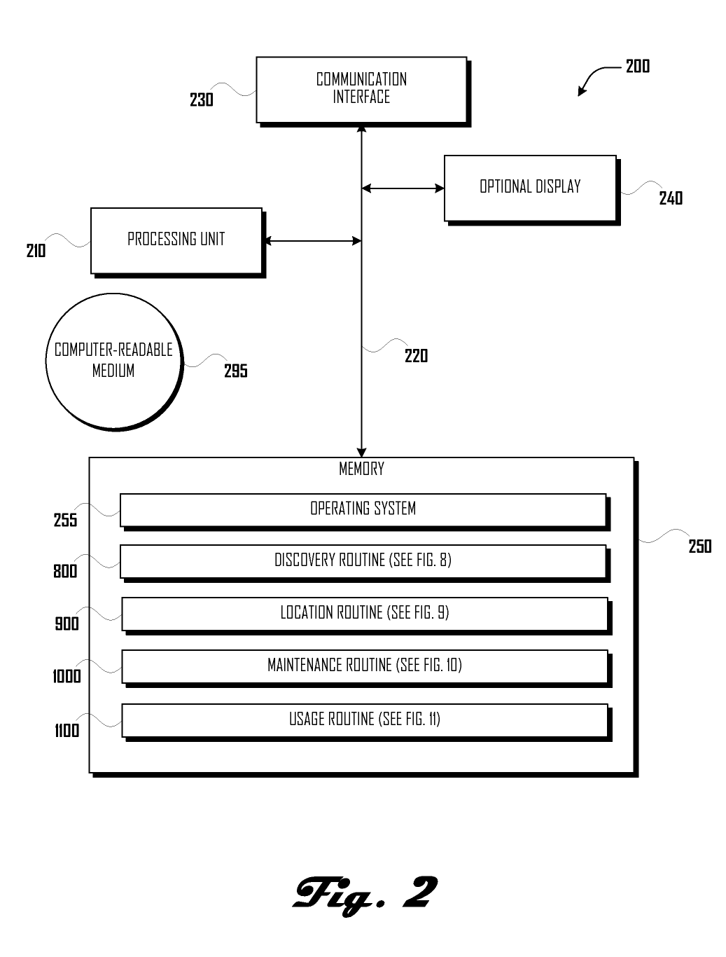

Referring now to the figures, FIG. 1 illustrates an example system 100 for tracking a medical device. The system 100 may include 2D matrix barcode labels 105A and 105B, labeled products 110A and 110B, product scanners 120A and 120B, a product identification and monitoring server 200, a product database 150, a product manufacturer 160, and a regulating entity 170. As illustrated, the 2D matrix code labels 105A and 105B may implement a variety of different encoding mechanisms including a QR barcode label 105A, or a Data Matrix barcode label 105B, or other type of 2D matrix code, for example. The system 100 may include more or fewer components, and each of the scanners 120A-B, the database 150, the server 200 may comprise multiple elements as well. In some further examples, additional functional and/or physical components may be added to the system illustrated by FIG. 1.

The products 110A and 110B may be any product that requires tracking and/or status updates to be provided on a periodic basis. In some embodiments, the labeled products 110A and 110B generally may include products with a shelf life and/or expiration date, including food, drink, medicine, chemicals, and other products whose quality or performance is negatively affected by the passage of time. In other embodiments, the products 110A and 110B may be products that are susceptible to counterfeiting, including movies, music, watches, clothing, software, art, and other products susceptible to counterfeiting. In such embodiments, the dynamic 2D matrix code labels 110A and 110B may, for example, be used to provide consumers with an anti-counterfeiting mechanism. In further embodiments, products 110A and 110B may comprise high-value products including cars, boats, electronic equipment (e.g., computers, televisions, stereos, smartphones, etc.), furniture, art and other high value products susceptible to theft. In these embodiments, the dynamic 2D matrix code labels 110A and 110B may be used to provide consumers with an anti-theft mechanism, for example. In yet even further embodiments, the product may comprise a medical device, including those discussed with reference to FIG. 12.

The 2D matrix codes 105 (i.e., 105A or 105B) may be static or dynamic. Traditionally, the 2D matrix codes 105 will remain static once they are printed. However, in some embodiments, the 2D matrix code 105 may be dynamic. A dynamic 2D matrix code label 105 may change after printing when a predetermined condition is met. Asset tracking industries susceptible to product shelf life and/or product expiration dates may use these dynamic 2D matrix code labels 105 to provide consumers with a product expiry mechanism. Example predetermined conditions may include time, temperature, or other threshold level exposure to an unwanted environment. For example, if a medical device is kept longer than recommended, the dynamic 2D matrix code label 105 may change to show an uncertified or expired condition. In another example, if the product experiences temperatures in excess of those recommended for storage then the dynamic 2D matrix code label 105 may alter its appearance to an uncertified or expired condition. In a further example, if the product is exposed to too much sunlight (e.g., beyond an ultra violet (UV) radiation threshold) then the dynamic 2D matrix code label 105 may alter its appearance to an uncertified or expired condition.

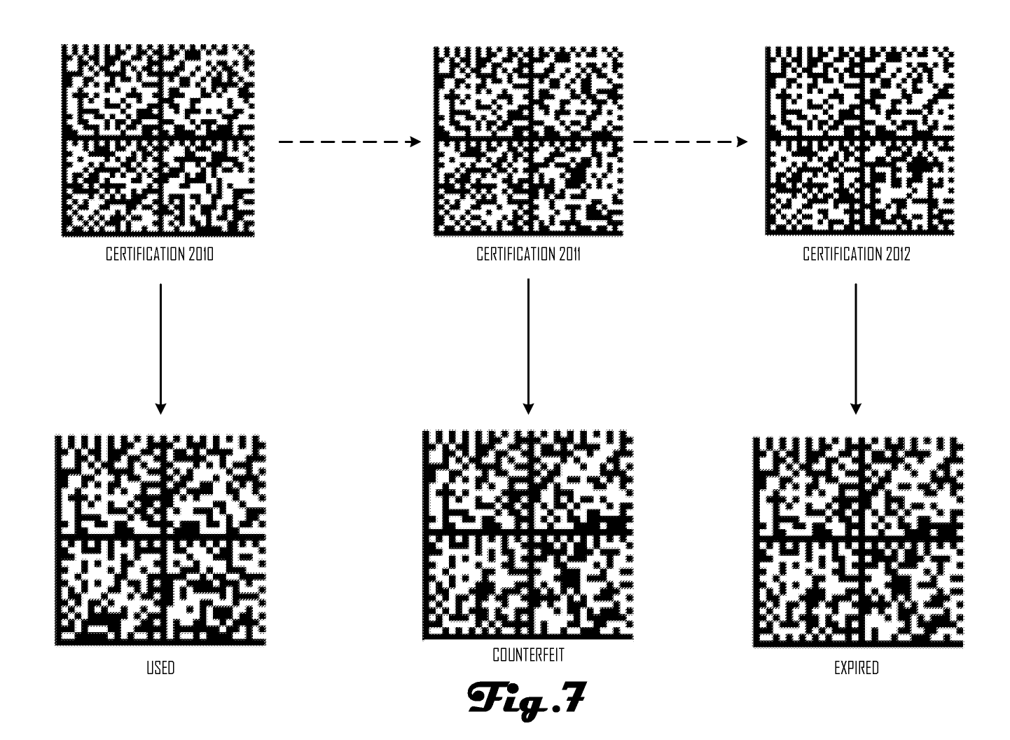

FIGS. 6 and 7 illustrate example 2D matrix code labels, QR barcodes, and Data Matrix barcodes that have been dynamically altered to be in a different operational state. Each state (e.g., USED, COUNTERFEIT, EXPIRED, and TIME CERTIFICATION) represents a circumstance in which a predetermined condition has triggered this change in the label. For example, a counterfeit situation may be triggered if multiple identical labels including make, model, and/or device identification have been scanned with different location information. An expired state may result from a variety of events including exceeding the recommended product shelf-life or exceeding usual service conditions (e.g., inclement weather). In one embodiment, the dynamic alteration for an expired device results in the barcode becoming unreadable. Another embodiment for an expired label redirects a link embedded in the 2D matrix code label to a new site, such as a recommended maintenance schedule for the device associated with the label. In one embodiment, a label associated with a device that has been used changes color to show the potential need for maintenance. Another embodiment calls for the removal of a layer of the label upon use. The removed portion could be kept by the device operator/user to provide additional information about the device to a subsequent operator and the remaining portion of the label would provide an indication that maintenance may need to be performed. For example, the remaining portion of the label may indicate that the electrode pads and/or battery should be checked and/or replaced. Alternatively, a new barcode label could be affixed to the device indicating that it had been used, until a subsequent maintenance visit returns the device to a certified operational state. In addition to a readable text certification (e.g., Certification 2010, 2011, and 2012 of FIGS. 6 and 7), an annual certification may also be embedded within the barcode label. This would allow a responding device operator to immediately recognize the condition of the equipment being used.

The dynamic alteration of the 2D matrix code label may be introduced in a variety of ways including use of a time/temperature-sensitive inks and/or paper, UV sensitive inks and/or paper, invisible/disappearing/security ink, and/or security paper. For example, digital piezoelectric inkjet ink may be used to print a 2D matrix code and to provide information about the particular thermal history of the labeled product. Use of time-temperature inks may allow changes in the dynamic 2D matrix code label to be custom tailored to the shelf life and optimum storage conditions of the respective product. Various UV sensitive inks may be used to create a dynamic 2D matrix code label where portions of the label disappear or appear depending on their exposure to UV light, which may be helpful when determining whether a product has been properly stored, for example. Similarly security inks/paper may be used to customize a dynamic 2D matrix code label. For example, in one embodiment, a security ink may be used to create a hidden certification date within the 2D matrix code label and thereby make detection of forged certification labels easier. Security inks typically may be revealed by application of at least one of heat, chemicals, light, or other developer. Thus, a 2D matrix code label may be dynamically adapted according to target events relevant to the product, such as heat, time, exposure, usage, or other factors.

In an example embodiment, removable multi-layered labels may be used for dynamic alteration of 2D matrix codes. Intermediate layers may indicate various operational states for a product, periodic certification, product usage, product expiration, unwanted element exposure, and/or other tracked event. Accordingly, upon undergoing a product event, such as use of an AED during a cardiac event, a layer of the 2D matrix code label could be removed to show another 2D matrix code label. In another embodiment, each layer may, for example, also utilize an informational color indicator, such as green for an active product ready for use, yellow for product maintenance ready for servicing, and red for product expiration ready for replacement. In yet another embodiment, the 2D matrix code may be slightly altered using removable translucent layers, where the base layer includes fundamental product information encrypted into the 2D matrix code label, but each removable layer adds additional information or blocks information encoded into the 2D matrix code, so that the resulting combination of all layers represents an active product label showing the device is ready for use/consumption.

Referring back to FIG. 1, the scanners 120A and 120B may be any computing device capable of scanning 2D matrix codes. Such computing devices may include a smartphone or a tablet, for example. The scanners may comprise a light source, a lens, and a light sensor for translating optical impulses into electrical ones to transmit barcode images. Scanner 120A and 120B may also include decoding software to analyze the barcode images (e.g., 105A) that are provided by the light sensor. Scanners 120A and 120B may further include a dedicated device such as a handheld barcode scanner, a pen reader, a laser scanner, a charge-coupled device (CCD) reader, or other camera-based reader to read the barcode. For example, in one embodiment, scanner 120A is a mobile device, such as a smartphone, configured to read 2D matrix codes using photo recognition software. In another embodiment, scanner 120B is a cell phone and the dynamic device tag 105A uses 2D matrix codes optimized for cell phones, such as QR Codes and Data Matrix codes that may be read quickly and accurately with or without an auto-focus camera.

The product identification and monitoring server 200 may include a processor or processing unit and memory (not shown) including instructions executable by the processor to perform functions of the server 200, for example. In some examples, the processor and memory may be coupled to each other. In alternative embodiments, the processor and memory may be separate components and coupled to the product identification and monitoring server. A more detailed description of the product identification and monitoring server will be discussed with reference to FIG. 2.

The database 150 may store all data received from the scanners 120A and 120B, for example. The data may be stored in any number of various forms from raw data obtained with the scanners 120A and 120B to processed data, processed by the server 200.

Components of the system 100 may be coupled to or configured to be capable of communicating via the Internet 130. The Internet 130 refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”). For example, product scanners 102A and 120B may be configured to be capable of communicating via the Internet 130 to communicate with server 200.

In other examples the components of the system 100 may be coupled or configured to be capable of communicating via a network (not shown), such as a local area network (LAN), wide area network (WAN), or wireless network (Wi-Fi). In addition, any of the components of the system 100 may be coupled to each other using wired or wireless communications. For example, communication links between the scanner 120B and the server 200 may include wired connections, such as a serial or parallel bus, or wireless links, such as Bluetooth, IEEE 802.11 (IEEE 802.11 may refer to IEEE 802.11-2007, IEEE 802.11n-2009, or any other IEEE 802.11 revision), or other wireless based communication links.

FIG. 2 illustrates an example product identification and monitoring server as referenced in system 100 of FIG. 1. The server 200 includes a communication interface 230 for connecting to a network. Such network might be the Internet 130 as described with reference to FIG. 1. In other examples, the communication interface 230 may use any of the other wired or wireless communication methods discussed with reference to FIG. 1. To facilitate the use of wired communication, the communication interface 230 may include a variety of input/output ports that each serve as a potential interface between the server 200 and other computers or peripheral devices such as the scanners 120A and 120B of FIG. 1. Example input/output ports may include Ethernet, FireWire, Serial, Parallel, coaxial cable, and/or Universal Serial Bus (USB) ports.

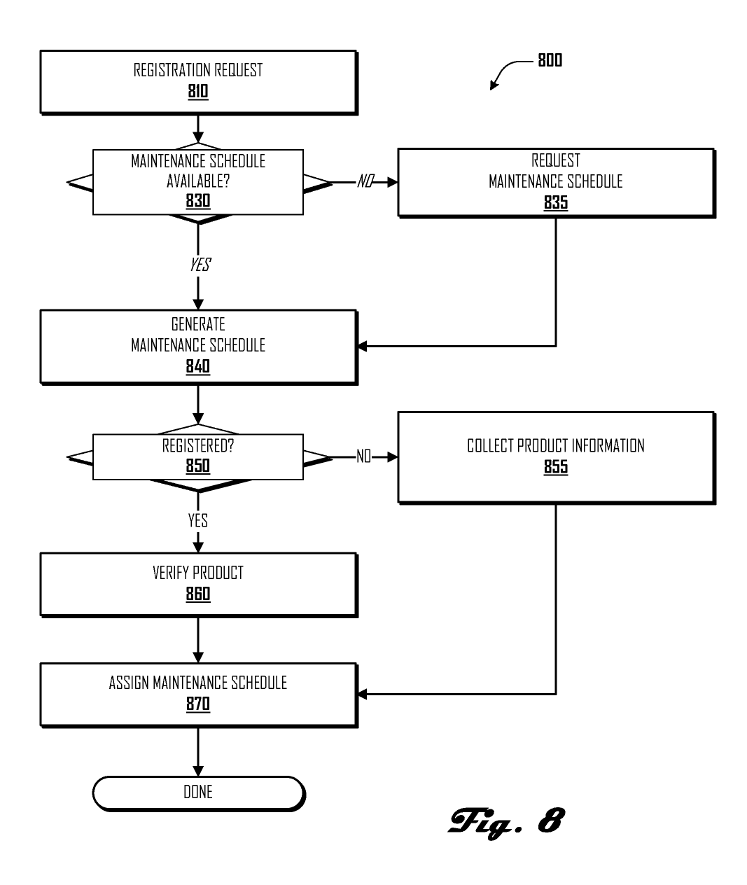

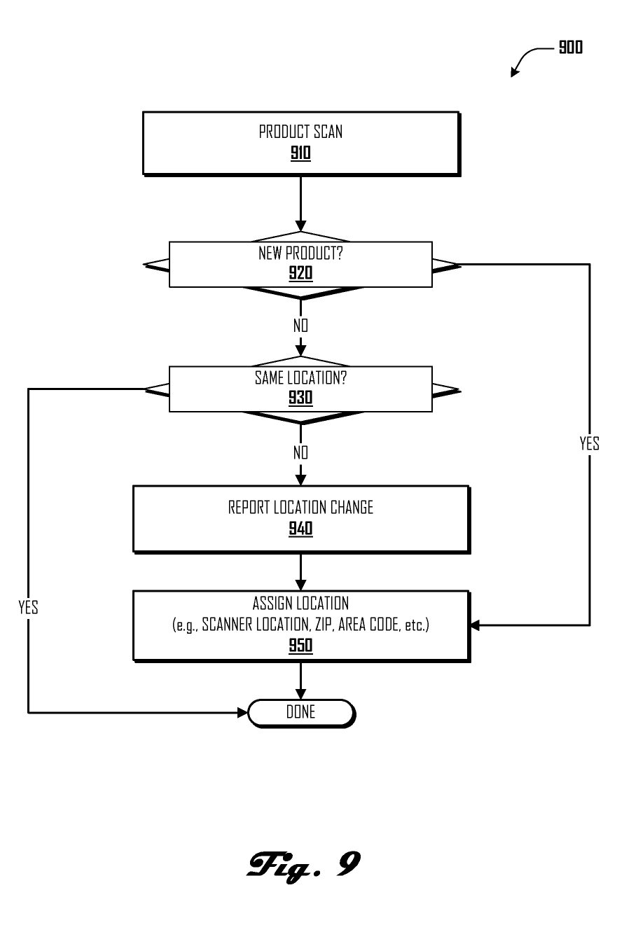

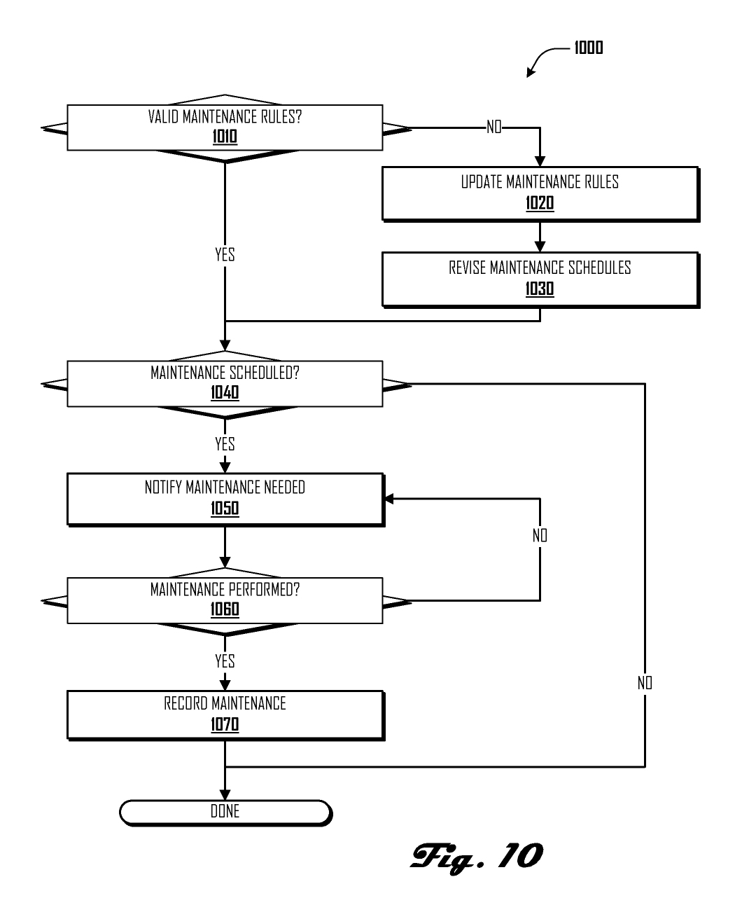

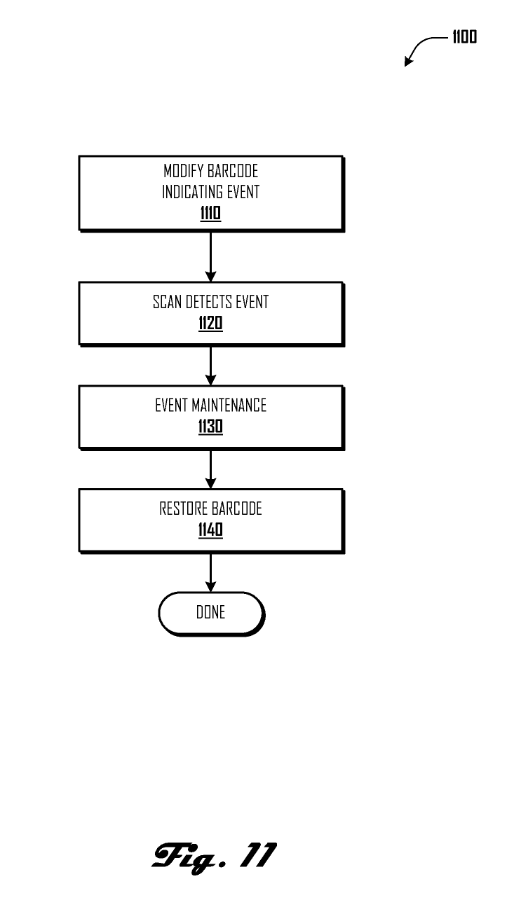

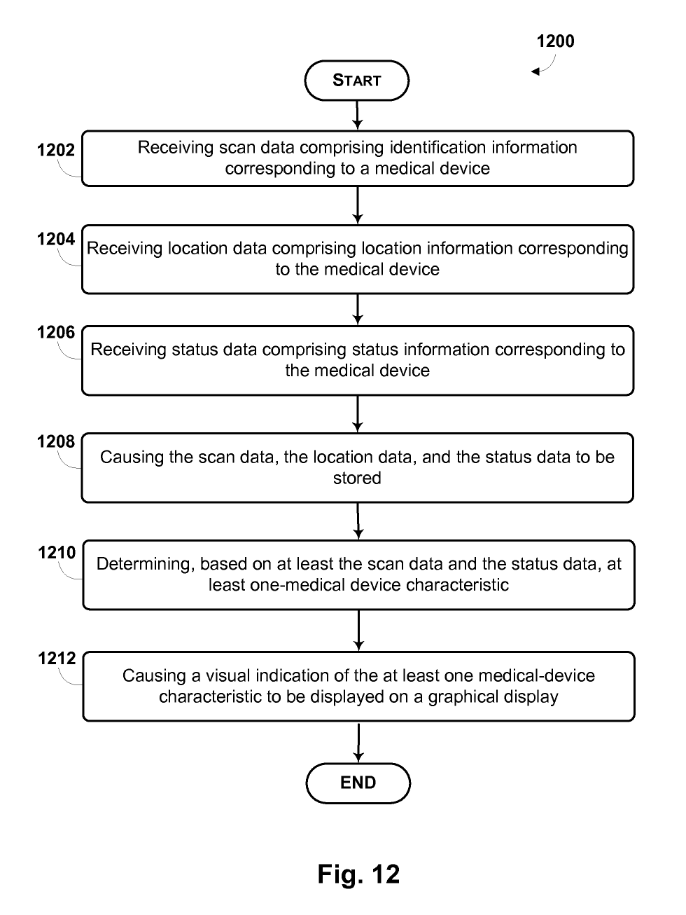

The server 200 also includes a processing unit 210, a memory 250, and an optional display 240, all interconnected along with the communication interface 230 via a bus 220. The memory 250 generally comprises a random access memory (“RAM”), a read only memory (“ROM”), and a permanent mass storage device, such as a disk drive. The memory 250 may store program code for a discovery routine 800 (see FIG. 8, discussed below), a location routine 900 (see FIG. 9, discussed below), a maintenance routine 1000 (see FIG. 10, discussed below), and a usage routine 1100 (see FIG. 11, discussed below) in accordance with example methods described herein. In addition, the memory 250 also stores an operating system 255. In FIG. 2, the components of the product identification and monitoring server 200 are shown in accordance with an example embodiment. However, in other embodiments, server 200 may include many more components than those shown in FIG. 2, all of which are contemplated herein.

Also disclosed in FIG. 2 is a physical and/or non-transitory computer-readable medium 295. The physical and/or non-transitory computer-readable medium 295 may be any type of physical and/or non-transitory computer readable media that stores data for short periods of time, such as register memory, processor cache, and/or Random Access Memory (RAM). The physical and/or non-transitory computer-readable medium 295 may also include non secondary or persistent long term storage, such as read only memory (ROM), optical or magnetic disks, and/or compact-disc read only memory (CD-ROM). The computer-readable media may also be any other volatile or non-volatile storage systems. The physical and/or non-transitory computer-readable medium 295 may be considered a computer-readable storage medium, for example, or a tangible storage device.

The foregoing program code (routines 800, 900, 1000, and 1100), for example, may be loaded from the physical and/or non-transitory computer-readable storage medium 295 into memory 250 of the server 200 using a drive mechanism (not shown) associated with a computer readable storage medium, such as a floppy disc, tape, DVD/CD-ROM drive, memory card, or the like. In some embodiments, software components may also be loaded via the communication interface 230, rather than via a computer readable storage medium 295.

Although one embodiment of server 200 has been described that generally conforms to conventional general purpose computing devices, server 200 may be any of a great number of devices capable of communicating with other network capable devices. In one embodiment, the server 200 is a distributed server, such a cloud server providing computational resources on demand via a network. Available cloud resources may include applications, processing units, databases, and file services. In this manner, the server 200 enables convenient, on-demand network access to a shared pool of configurable asset monitoring and tracking related computing services and resources (e.g., networks, servers, storage, applications, and services) that may be rapidly provisioned and released with minimal management effort or service provider interaction. These services may be configured so that any computer connected to the Internet 130 is potentially connected to the group of asset monitoring and tracking applications, processing units, databases, and files or, at the very least, is able to submit asset registration requests, asset monitoring scans, and/or access collected asset information. In this manner, the asset data maintained by server 200 may be accessible in a variety of ways by a client device, for example, a personal computer, a game console, a set-top box, a handheld computer, a cell phone, or any other device that is capable of accessing the Internet 130.

### C. Example Methods

FIG. 12 illustrates a block diagram of an example method for tracking a product. In this embodiment, the product takes the form of a medical device, and will be referenced as such in the discussion of method 1200. Method 1200, shown in FIG. 12, presents an embodiment of a method that, for example, may be carried out in the system 100 depicted in FIG. 1, and may be performed using the scanners 120A and 120B illustrated in FIG. 1. Method 1200 may include one or more operations, functions, or actions as illustrated by one or more of blocks 1202-1212. Although the blocks are illustrated in sequential order for the method 1200 and other processes and methods disclosed herein, these blocks may also be performed in parallel, and/or in a different order than those described herein. Also, the various blocks may be combined into fewer blocks, divided into additional blocks, and/or removed based upon the desired implementation.

In addition, for the method 1200 and other processes and methods disclosed herein, the flowchart shows functionality and operation of one possible implementation of present embodiments. In this regard, each block may represent a module, a segment, or a portion of program code, which includes one or more instructions executable by a processor or computing device, such as those described in reference to FIG. 1, for implementing specific logical functions or steps in the process. The program code may be stored on any type of computer readable medium or memory, such as those described in reference to FIG. 2.

In addition, for the method 1200 and other processes and methods disclosed herein, each block in FIG. 12 may represent circuitry that is wired to perform the specific logical functions in the process.

Initially, at block, 1202, the method includes receiving scan data including identification information corresponding to a medical device. The medical device may be, or include any instruments or related articles which are intended for use in the diagnosis or treatment of disease. Such devices are applied externally or internally to patients to affect the structure or function of their body, and do not achieve their purpose through chemical action or metabolism. Example medical devices may include durable medical equipment (e.g. wheelchairs), externally-applied devices (e.g. automated external defibrillator), internally-applied devices (e.g. pacemaker) or disposable medical devices (e.g. bandages). Other medical devices may include a blood glucose monitor, a blood pressure monitor, a dialysis machine, an electrocardiography (ECG) machine, a wireless monitor, a laryngoscope, a bronchoscope, a pacemaker, or a stent, for example. A server or other computing device may receive the scan data comprising identification information from a 2D matrix barcode, a QR barcode, or a Data Matrix barcode, for example. Other 2D matrix codes may be used to obtain the identification information. In some examples, the 2D matrix code, the QR barcode, or the Data Matrix barcode may be affixed to the medical device. In other examples, the 2D matrix code, QR barcode, or the Data Matrix code may be associated with the medical device, but not affixed to it. Example computing devices may include a smartphone or a tablet, among other examples.

The identification information may include a name, a serial number, a make, a model, a date of manufacture, an owner, and/or an original location of installation, for example. Installation may be defined as the placement of the medical device in its current location. For instance, a smartphone may scan a QR barcode affixed to an AED and receive identification information for the AED indicating that the AED was manufactured in June of 2001 and originally installed in Chicago, Ill. In other examples, more or less identification information may be received by the smartphone, after scanning the QR barcode. In one example, when a computing device scans the QR barcode it may receive a date and time stamp associated with the medical device.

At block 1204, the method 1200 includes receiving location data including location information corresponding to the medical device. The location information may include coordinates obtained from a Global Positioning System (GPS), such as street address information, and/or any other geographical information. The location information may be obtained, for example, by the computing device that receives the scan data discussed in the foregoing step, step 1202. In one instance, continuing with the example above, the GPS system associated with the smartphone may be used to provide the location information by using location services included in the smartphone.

At block 1206, the method 1200 includes receiving status data including status information corresponding to the medical device. The status data may be used by an operator of the medical device (e.g., an MD) to verify the status of the device, or for other purposes. The status data may include a date of use, a registered owner, location-of-use, and a reason-for-use, for example. The reason-for-use may comprise, for example, checking components of the medical device, replacing components of the medical device, and for clinical use. Other status data may be provided. In one instance, similar to steps 1202 and 1204, the smartphone may receive the status data after scanning the QR barcode. In some embodiments a status request may be displayed on a graphical display prior to receiving the status data. For example, a request may be displayed on the screen of the smartphone prior to receiving any status data. Upon executing the request, by for example, pressing a status request button displayed on the screen, a user may initiate a request for status data. Once the status request is executed the user will be provided with any known status information (i.e., status data) corresponding to the medical device. This known status data may have been provided by a prior user of the medical device. The status data may be provided from a server similar to the one illustrated in FIG. 2, for example. The status request may be executed in various ways including, for example, a mouse click.

Continuing with the example above, the user of the smartphone may request status data relating to the AED, and upon request, receive status data indication that the AED was last used in August of 2011, and has a maintenance date that has expired. Accordingly, the user may use this information in deciding whether or not to use the AED.

At block 1208, the method 1200 includes causing the scan data, the location data, and the status data to be stored. The scan data, the location data, and the status data may be stored in the database depicted in FIG. 1, for example. In one embodiment, the scan data, the location data, and the status data may be automatically stored in response to receiving the scan data, location data, and status data. In some examples, the scan data, location data, and status data may be an update to the data already received. In one example, once again continuing with the foregoing smartphone example, upon receiving the scan data, the location data, and the status data, the smartphone may automatically store all of the data in the database. In other words, in response to receiving the scan data, the location data, and the status data, and without further instruction from the user, the data will be stored. In doing so, the smartphone may transmit all of the data to a server along with a store instruction, instructing the server to store the scan data, the location data, and the status data. The message may take various forms, and utilize any techniques that are generally known in the art. The server may be the server described in FIG. 2, for example. Once the server has received the store instruction, the server may store the scan data, the location data, and the status data in the database.

At block 1210, the method 1200 includes determining, based on at least the scan data and the status data, at least one medical-device characteristic. In other embodiments, other information may be used to determine the medical-device characteristic. The medical device-characteristic includes information that is relevant to the use of the medical device at the time of use of the medical device. The medical-device-characteristic may include information including a date of use, a location of use, a change in registered owner, a reason for use, an instruction manual for use, a maintenance schedule, operational information, and expiration information, for example. Such information may have been associated with the medical device previously by another user, for example, and may include data similar to that of the status data. In other examples, the medical-device characteristic information may have been associated with the medical device at the time of installation. The medical-device characteristic may be determined for example by transmitting the scan data and the status data to a server via a wired or wireless network and receiving the at least one medical-device characteristic. In the foregoing example, the medical-device characteristic may be the maintenance date that has expired for the AED.

At block 1212, the method 1200 includes causing a visual indication of the at least one medical-device characteristic to be displayed on a graphical display. The graphical display may be any display that is capable of displaying the visual indication. For example, the graphical display may comprise the screen of a laptop or monitor of a desktop computer, for example. In such a scenario, the user of the medical device may proceed to a computer or laptop to receive the visual indication from a server such as the server depicted in FIG. 2, for example. The server may transmit the data over the Internet 130, for example. In the foregoing smartphone example, the visual indication may be displayed on the screen of the smartphone. The visual indication may comprise data associated with the medical-device characteristic, and be presented in the form of an HTML web-page, for example. In some instances, the HTML webpage may present the medical-device characteristic in the form of an HTML form that is capable of receiving user input associated with that medical-device characteristic. In other embodiments, the medical-device characteristic may be presented on the graphical display in association with an application such as a smartphone application. In such an embodiment, a user may input data relating to the medical-device characteristic based via the application. Many possibilities are possible for the display of the visual indication and are contemplated herein.

In some embodiments, once the visual indication has been displayed, a server or other computing device may receive new status data regarding the medical-device characteristic via input by a user, for example. For instance, a user may utilize the HTML form (i.e., visual indication of the medical-device characteristic) to input new status data regarding the medical-device characteristic. Once the new status data has been input by the user, the new status data may be stored in a manner similar to that which is described with respect to step 1208 of method 1200. For instance, the user of the smartphone may utilize an application to provide new status data indicating that the user has performed maintenance on the AED, and provide a new maintenance date. Upon receiving this new status data, the server can store the data in a database allowing the new status data to be associated with the AED for a future user.

### D. Example Scenarios

Referring back to FIG. 3, FIG. 3 illustrates another example system similar to the system illustrated in FIG. 1. The system in FIG. 3 may be used to carry out method 1200, for example. In other examples, the system in FIG. 3 may be used to carry out the methods (i.e., routines) of FIGS. 8, 9, and 10. Aspects of the methods shown in any of FIGS. 8, 9, and/or 10 may be carried out before, after, or in connection with method 1200 described above. The system 300 includes a product 310, 2D matrix code 305, scanner 320, server 340, and device database 350.

FIG. 4 illustrates the system embodiment of FIG. 3 for a particular medical-device: a defibrillator/monitor. In FIG. 4, the system 400 includes a defibrillator/monitor 410, scanner 420, server 440, and device database 450. The defibrillator/monitor 410 includes electrodes 411, a battery 413, and memory 415. In one embodiment, the electrodes 411 and battery 413 are fungible components, which may be selectively disposable after replenishment.

The memory 415 includes diagnostic monitoring data 417 to help identify life threatening cardiac arrhythmias and event data 419 collected from a cardiac event. If the defibrillator/monitor 410 is an AED, then the defibrillator/monitor 410 automatically diagnoses the heart rhythm and determines if a shock is needed. The portion of memory 415 dedicated to diagnostic monitoring data 417 may include recorded electrocardiograms (ECG) of life-threatening cardiac arrhythmias, which if left untreated could lead to cardiac arrest. The diagnostic monitoring data 417 may also include treatment patterns to be applied when such treatable cardiac arrhythmias are detected. The event data 419 may include ECG data of the patient condition as measured via the electrode leads 411. In one embodiment, the event data 419 may also store other details of the event, including the time the unit was activated, the location of the event, and the number and strength of any shocks delivered. Some defibrillator/monitors 410 also have the ability to monitor the actions taken by the rescuing operator of the device via sound and/or video recordings in order to ascertain if these had any impact on the survival outcome of the patient. Some AED units even provide real-time or post-event feedback on the quality of the ongoing rescue efforts, such as monitoring data collected via the electrode pads 411 to determine whether the compressions provided by the rescuer are adequate to maintain blood flow.

Scanner 420 may identify the defibrillator/monitor 410 by scanning the dynamic device tag 405. The dynamic device tag may be any 2D matrix code as discussed with reference to FIG. 2, for example. Using the method illustrated in FIG. 12, for example, the scanner 420 may track the defibrillator/monitor 410. Upon identification, scanner 420 and/or server 440 may collect the event data 419 for storage in the device database.

In one example embodiment, the recorded data in memory 415 may be downloaded or reported. The recorded data may be stored in database 450 in a manner as discussed with respect to FIG. 12, for example. For instance, the recorded data may be captured, recorded, and/or printed for later review by trained medical personnel. In another embodiment, a report may also constitute an electronic transmission of data via the Internet. In a further embodiment, data on a defibrillator/monitor 410 may be downloaded via an I/O interface, such as a USB port or Ethernet port, to scanner 420 or a portable memory device (not shown).

More particularly, the data in memory 415 may be communicated to the device database 450 via server 440. This data may be used to help optimize performance and maintenance schedule of defibrillator/monitor 410. Alternatively, upon scanning the dynamic device tag 405, server 440 may notify scanner 420 of the need to upgrade the diagnostic monitoring data 417, for example, by using method 1200 described with reference to FIG. 12. By monitoring the collected data recorded by the defibrillator/monitor 410, such as in device database 450, the manufacturer, regulating organization, and/or responsible entity of the defibrillator/monitor 410 is able to see the effectiveness of both CPR and defibrillation for events. Accordingly, device specific modifications can then be made based on the collected performance information during a particular event.

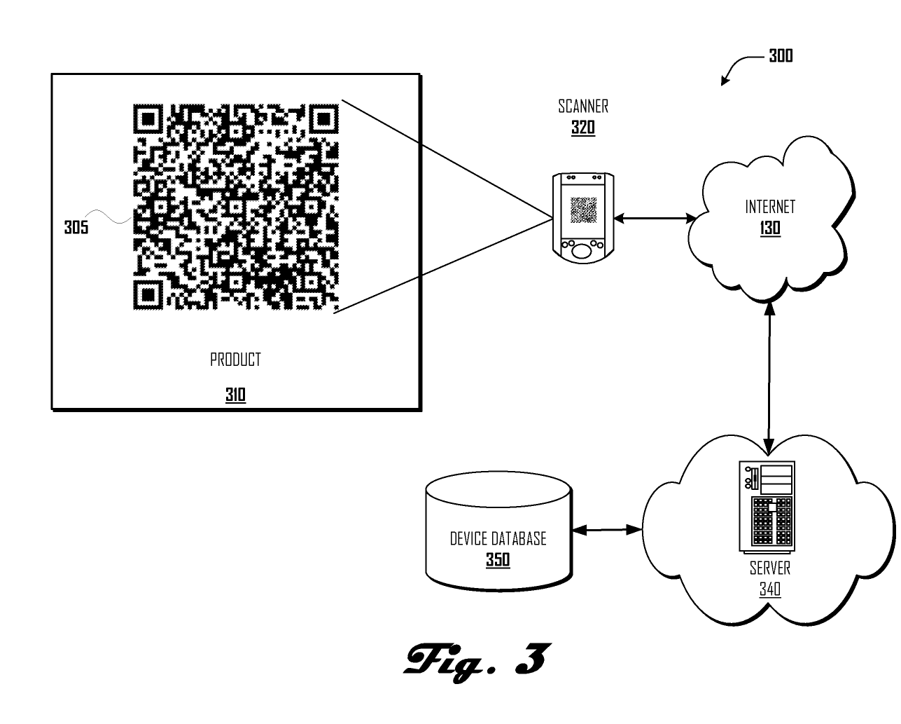

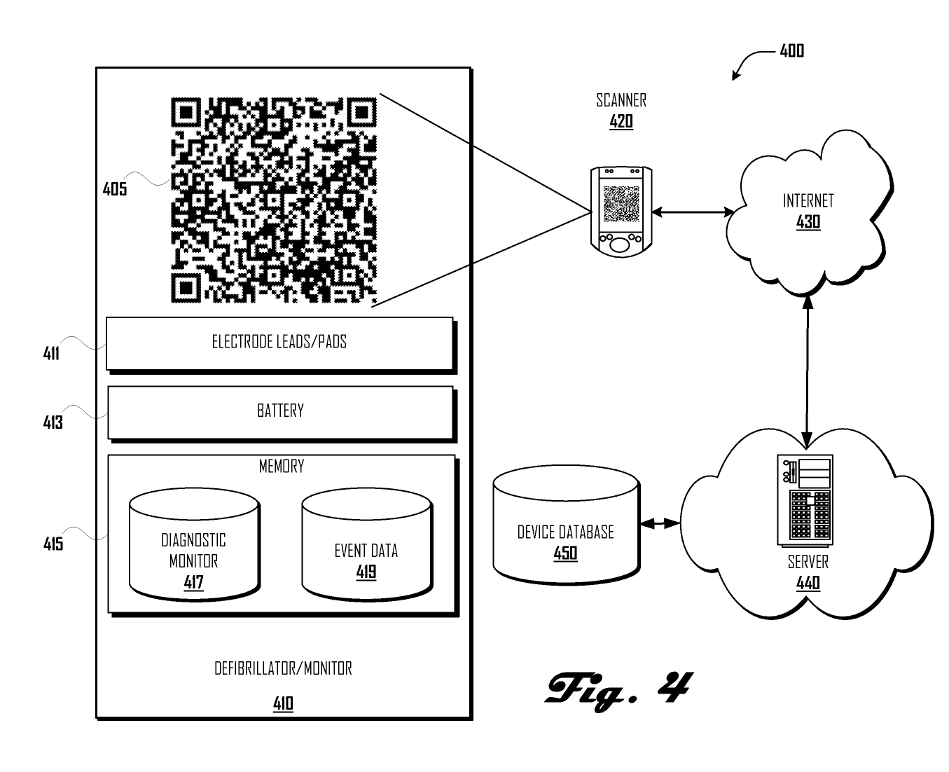

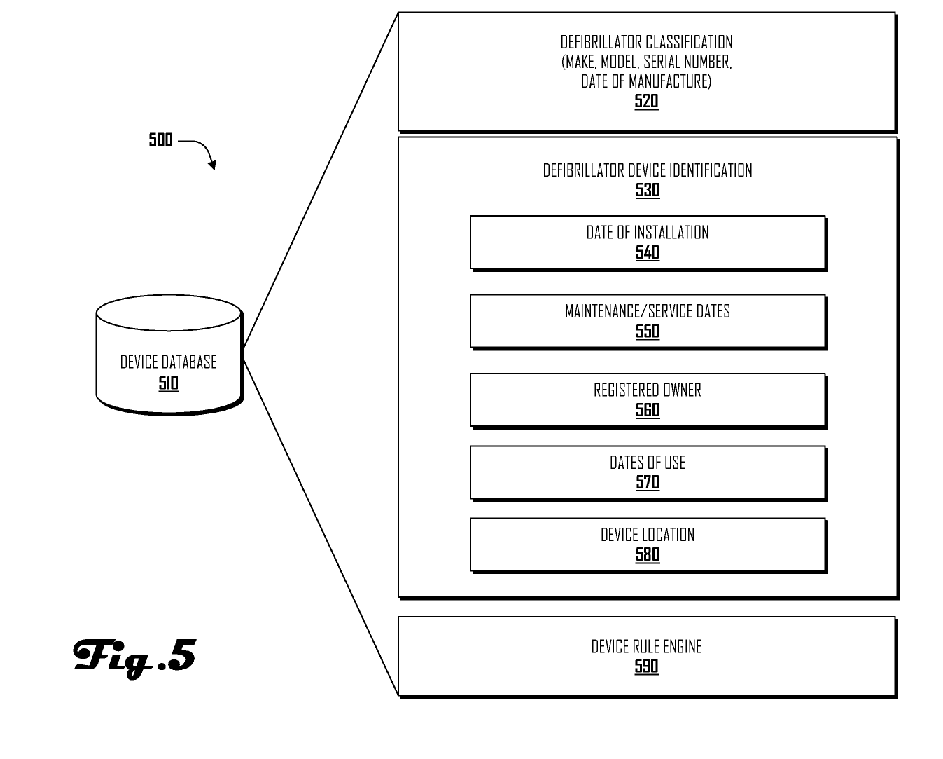

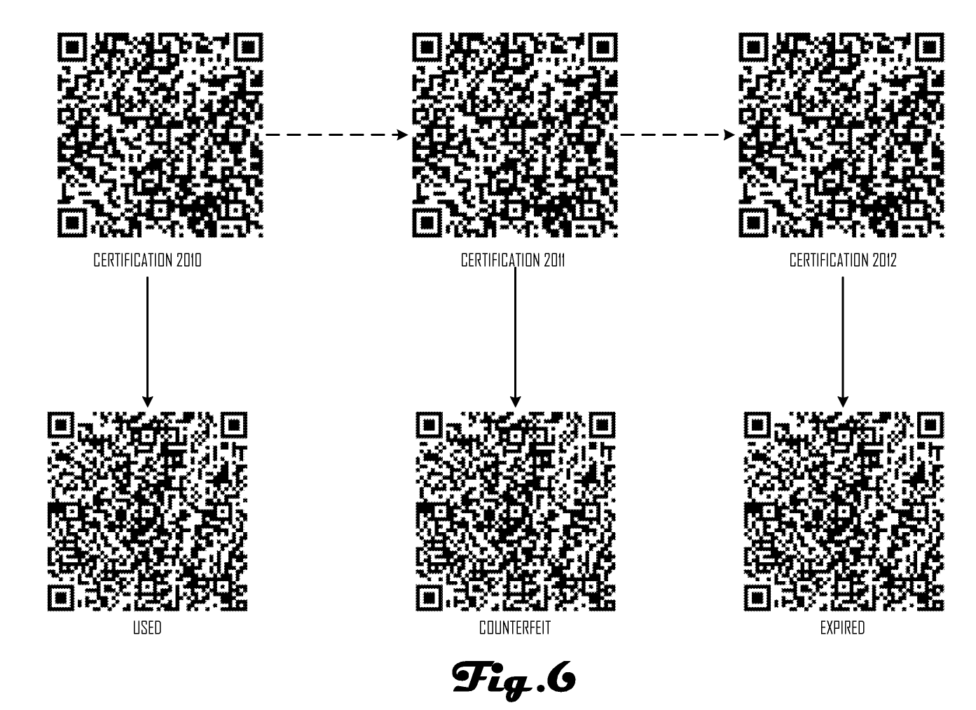

FIG. 5 illustrates a defibrillator device database 510 in accordance with one embodiment of the system shown in FIG. 4. The defibrillator device database 510 comprises defibrillator classification information 520 that includes specific product information such as make, model, date of manufacture, product serial number, and/or other information assigned at the time the device is built. The defibrillator device database 510 also includes, but is not limited to, specific defibrillator device identification information 530, such as date of use 540, maintenance and service records 550, registered owner 560 responsible for the defibrillator, dates of use 570, if any, and/or device location information 580. Accordingly, defibrillator device identification information 530 typically records interactions with the device after the initial registration. By tracking information in this manner, the database is able to identify upcoming maintenance for a particular defibrillator device based on usage and location. The defibrillator device database 510 also includes device rule engine 590, which establishes the preferred maintenance schedule for a particular device based in part on defibrillator classification information 520 and defibrillator device identification information 530. The device rule engine 590 may be adapted as improvements are developed for a particular device.

Referring now to FIG. 8, FIG. 8 illustrates a flow diagram for a product discovery and validation process routine 800, in accordance with one embodiment. As previously illustrated in FIG. 2, the memory 250 may store program code for the product discovery and validation process routine 800 for registering a specific product/device and assigning an appropriate maintenance schedule. Initially, routine 800 receives a registration request for a product in subroutine block 810. This registration request may originate from the product manufacturer or a subsequent purchaser responsible for the product.

In query block 830, routine 800 determines whether a maintenance schedule is available for the particular make and model of the product. That maintenance schedule may be a medical-device characteristic as described in reference to method 1200, for example. If no schedule is available, routine 800 requests a maintenance schedule in subroutine block 835. The maintenance schedule may originate from a variety of sources including, but not limited to, the manufacturer, purchaser, approved third-party maintenance provider, and/or a regulatory entity associated with the product.

Once a recommended maintenance schedule is available, routine 800 generates a custom maintenance schedule for the particular product being registered in subroutine block 840. Routine 800 determines whether the particular product was previously registered in query block 850. If not, routine 800 collects product information in subroutine 855. The product information may be obtained using the scan process described in method 1200. For example, in one embodiment, this may include defibrillator classification information 520 and/or specific defibrillator device identification information 530, if available. If the product was previously registered, routine 800 verifies authenticity of the product in subroutine 860 so that the database may be updated. In one embodiment, verification may include requesting defibrillator classification information 520 and/or specific defibrillator device identification information 530 to compare against information in the existing database. Product verification may also reveal counterfeiting when multiple registration requests are made for the “same” product (e.g., same serial number) from multiple disparate locations. Alternatively, product verification may also reveal theft of high value items.

Once the specific product information is available, routine 800 assigns a custom maintenance schedule in subroutine 870. In one embodiment, the customized maintenance schedule is based on defibrillator classification information 520 and/or specific defibrillator device identification information 530.

Referring now to FIG. 9, FIG. 9 illustrates a flow diagram for location identification and product association process routine 900, in accordance with one embodiment. The location identification and product association process routine 900 determines and/or confirms product installation location. A product scan is received by routine 900 in block 910. The scan may be performed in the manner described with respect to method 1200, for example, and may be obtained using a scanner such as those depicted in FIG. 1. In one embodiment, the product scan may include information including GPS coordinates, ZIP code information, area code information, network information, and/or other relative geographical information that may be derived from the scanner. In query block 920, routine 900 determines whether this is a new product. In one embodiment, routine 900 may check device database 510 to determine whether the scanned product matches any recorded defibrillator classification information 520. If there is no existing record for the scanned product, routine 900 assigns the scanned location to the product in block 950. Otherwise routine 900 determines whether the recorded location is the same as the location associated with the most recent scan in query block 930. If the scan location is not the same, routine 900 reports the location change in block 940 and assigns the new location to the product in block 950. Otherwise routine 900 returns since the product is in the same location as previously recorded.

Referring to FIG. 10, FIG. 10 illustrates a flow diagram for product monitoring and maintenance process routine 1000, in accordance with one embodiment. In one embodiment, the product monitoring and maintenance process routine 1000 may be used to monitor device maintenance recommendations and notify manufacturer, regulators, and/or the registered owner of upcoming maintenance. Routine 1000 checks whether the existing maintenance rules are valid in query block 1010. This determination may be made, for example, by using method 1200 to receive status data, and the status data may include the maintenance rules. If existing rules are outdated, routine 1000 updates the maintenance rules in block 1020. The update may be performed using method 1200, for example. For instance, a user may be provided with an HTML form in which the user can provide the updated maintenance schedule (i.e., data regarding the medical-device characteristic). In one embodiment, updated maintenance rules may be obtained from manufacturer, purchaser, and/or a regulatory entity. Once the maintenance rules for a particular product are updated, routine 1000 updates the specific maintenance schedule, if necessary, for each individual product in accordance with the new rule set in block 1030. In one embodiment, the maintenance schedule for each product is only updated upon receiving a product scan. This reduces processing time for each product update, but may lengthen the corresponding scan time. However, the delayed update process may risk not timely reflecting urgent product updates in an individual maintenance schedule. Another approach proactively updates each individual maintenance schedule upon receiving an urgent product update, but waits for a scan event before updating for less urgent changes. In another embodiment, a valid 2D matrix code label must be maintained on the device in order to maintain device warranty.

Routine 1000 checks for scheduled maintenance in query block 1040 and notifies the respective entity responsible for maintenance in block 1050 or returns if no maintenance is scheduled. The parameters of a particular maintenance check query may be defined by the manufacturer, the purchaser, a regulating entity, and/or the party responsible for maintenance. Accordingly, routine 1000 may look for upcoming periodic maintenance (e.g., daily, weekly, monthly, and annual) as well as device specific maintenance, such as electrode replacement after use or early battery replacement due to failure/use. Moreover, the relative frequency of the maintenance reports may also be dictated by routine 1000 in accordance with instructions defined by the manufacturer, the purchaser, a regulating entity, and/or the party responsible for maintenance.

In one embodiment, routine 1000 checks whether scheduled maintenance was performed as scheduled in query block 1060. If the scheduled maintenance has not yet been completed, routine 1000 may send a reminder notification in block 1050 to the respective entity responsible for maintenance. Otherwise routine 1000 records the maintenance in block 1070 and returns.

Referring now to FIG. 11, FIG. 11 illustrates a flow diagram for a product usage, data collection and restoration process routine 1100, in accordance with one embodiment. Upon experiencing a product event, the 2D matrix code label is modified in block 1110 to reflect the occurrence of the product event. A product event may include product usage, product expiration, unwanted exposure, and/or other tracked event. In block 1120, the product usage, data collection and restoration process routine 1100 detects the event during a periodic scan of the product barcode label. If necessary, routine 1100 also reports the product being scanned for event maintenance in block 1130. In one embodiment, event maintenance for usage of a defibrillator includes replacing electrodes and checking battery. Following event maintenance, routine 1100 restores the product barcode in block 1140, incorporating relevant event information where appropriate. In situations where a product may be completed restored, a new dynamic barcode may be issued to the product.

Although specific embodiments have been illustrated and described herein, a whole variety of alternate and/or equivalent implementations may be substituted for the specific embodiments shown and described without departing from the scope of the present disclosure. This application is intended to cover any adaptations or variations of the embodiments discussed herein.

1. A computer-implemented method comprising:
receiving scan data comprising identification information corresponding to a medical device;
receiving location data comprising location information corresponding to the medical device;
receiving status data comprising status information corresponding to the medical device;
causing the scan data, the location data, and the status data to be stored;
determining, based on at least the scan data and the status data, at least one medical-device characteristic; and
causing a visual indication of the at least one medical-device characteristic to be displayed on a graphical display.

2. The method of claim 1, wherein the identification information comprises one or more of a name, a serial number, a make, a model, a date of manufacture, an owner, and an original location of installation.

3. The method of claim 1, wherein the status information comprises one or more of a date of use, a location-of-use, and a reason-for-use.

4. The method of claim 3, wherein the reason-for-use comprises one or more of checking a battery of the medical device, checking an alarm of the medical device, replacing components in the medical device, and clinical use.

5. The method of claim 1, wherein the at least one medical-device characteristic comprises one or more of a date of use, a location of use, a change in registered owner, reason for use, medical device use instructions, a manual, a maintenance schedule, operational information, usage information, and expiration information.

6. The method of claim 1, wherein causing the scan data, the location data, and the status data to be stored comprises causing the scan data, location data, and status data to be automatically stored in a database.

7. The method of claim 1, wherein the at least one medical device comprises at least one of an automated external defibrillator (AED), a blood glucose monitor, a blood pressure monitor, a dialysis machine, an electrocardiography (ECG) machine, a wireless monitor, a laryngoscope, a bronchoscope, a pacemaker, and a stent.

8. The method of claim 1, wherein the identification information corresponding to the medical device is identification information provided in a two-dimensional matrix code affixed to the medical device.

9. The method of claim 1, wherein determining, based on at least the scan data and the status data, the at least one medical-device characteristic, comprises:
transmitting the scan data and the status data to a server; and
receiving the at least one medical-device characteristic.

10. The method of claim 1, wherein receiving the location data comprising location information corresponding to the medical device comprises receiving the location information from a global positioning system within a computing device used to scan the medical device.

11. The method of claim 1, further comprising:
before receiving the status data comprising the status information corresponding to the medical device, causing a medical-device status request to be displayed on the graphical display.

12. The method of claim 11, wherein the medical-device status request is displayed in response to receiving the scan data.

13. The method of claim 1, further comprising:
after causing the visual indication of the at least one medical-device characteristic to be displayed, receiving new status data corresponding to the medical device; and
causing the new status data to be stored.

14. The method of claim 13, wherein receiving the new status data corresponding to the medical device comprises at least one of (i) receiving the new status data after operation of the medical device, (ii) receiving the new status data after determining the medical device is properly functioning, (iii) or receiving the new status data after upgrading software of the medical device.

15. A system comprising:
a processor;
a physical computer readable medium; and
program instructions stored on the physical computer readable medium and executable by the processor to:
receive scan data comprising identification information corresponding to a medical device;
receive location data comprising location information corresponding to the medical device;
receive status data comprising status information corresponding to the medical device;
cause the scan data, the location data, and the status data to be stored;
determine, based on at least the scan data and the status data, at least one medical-device characteristic; and
cause a visual indication of the at least one medical-device characteristic to be displayed on a graphical display.

16. The system of claim 15, wherein
the identification information comprises one or more of a name, a serial number, a make, a model, a date of manufacture, an owner, and an original location of installation;
the status information comprises one or more of a date of use, a location-of-use, and a reason-for-use;
the at least one medical-device characteristic comprises one or more of a date of use, a location of use, a change in registered owner, a reason for use, medical device use instructions, a manual, a maintenance schedule, operational information, usage information, and expiration information; and
the medical device comprises at least one of an automated external defibrillator (AED), a blood glucose monitor, a blood pressure monitor, a dialysis machine, an electrocardiography (ECG) machine, a wireless monitor, a laryngoscope, a bronchoscope, a pacemaker, and a stent.

17. The system of claim 15, wherein causing the scan data, the location data, and the status data to be stored comprises, causing the scan data, location data, and status data to be automatically stored in a database.

18. The system of claim 15, the system further comprising program instructions stored on the physical computer readable medium and executable by the processor to:
transmit the scan data and the status data to a server; and
receive the at least one medical-device characteristic.

19. The system of claim 15, the system further comprising program instructions stored on the physical computer readable medium and executable by the processor to:
after causing the visual indication of the at least one medical-device characteristic to be displayed, receive new status data corresponding to the medical device; and
cause the new status data to be stored.

20. A physical computer readable medium having instructions stored thereon, the instructions comprising:
instructions for receiving scan data comprising identification information corresponding to a medical device;
instructions for receiving location data comprising location information corresponding to the medical device;
instructions for receiving status data comprising status information corresponding to the medical device;
instructions for causing the scan data, the location data, and the status data to be stored;
instructions for determining, based on at least the scan data and the status data, at least one medical-device characteristic; and
instructions for causing a visual indication of the at least one medical-device characteristic to be displayed on a graphical display.

21. The physical computer readable medium of claim 20, wherein
the identification information comprises one or more of a name, a serial number, a make, a model, a date of manufacture, an owner, and an original location of installation;
the status information comprises one or more of a date of use, a location-of-use, and a reason-for-use;
the at least one medical-device characteristic comprises one or more of a date of use, a location of use, a change in registered owner, a reason for use, medical device use instructions, a manual, a maintenance schedule, operational information, usage information, and expiration information; and
the at least one medical device comprises at least one of an automated external defibrillator (AED), a blood glucose monitor, a blood pressure monitor, a dialysis machine, an electrocardiography (ECG) machine, a wireless monitor, a laryngoscope, a bronchoscope, a pacemaker, and a stent.

22. The physical computer readable medium of claim 20, the instructions further comprising instructions for, in response to receiving the scan data, location data, and status data, automatically storing the scan data, the location data, and the status data in a database.

23. The physical computer readable medium of claim 20, the instructions further comprising:
instructions for transmitting to a server the scan data, the location data, and the status data; and
instructions for transmitting to the server a store instruction to store the scan data, the location data, and the status data in a server database.

24. The physical computer readable medium of claim 20, the instructions further comprising:
instructions for transmitting the scan data and the status data to a server; and
instructions for receiving the at least one medical-device characteristic.

25. The physical computer readable medium of claim 20, the instructions further comprising:
instructions for, after causing the visual indication of the at least one medical-device characteristic to be displayed, receiving new status data corresponding to the medical device; and
instructions for causing the new status data to be stored.
